(19) United States
(12) Patent Application Publication
(10) Pub. No.: US 2010/0176950 A1
(43) Pub. Date: Jul. 15, 2010

(54) VENDING ENCLOSURE RECOVERY METHOD AND SYSTEM

(76) Inventors: Joel Bartholf, Macon, GA (US); Roger Hayward, Long Beach, CA (US); Richard Fuller, Gilroy, CA (US)

Correspondence Address: Haynes and Boone, LLP;IP Section, 2323 Victory Avenue, SUITE 700, Dallas, TX, 75219, US

(21) Appl. No.: 12/354,253

(22) Filed: Jan. 15, 2009

(51) Int. Cl. G08B 13/14

(52) U.S. Cl. 340/572.7; 340/572.1

(57) ABSTRACT

A tracking system and method provide updated location and status information of a vending machine even after the vending machine is moved from its installed location. This allows law enforcement to use the updated location information to locate and recover the vending machine and the assets contained therein during a theft or in other security breach situations. A method also provides for automatically assigning the vending machine to an installation location using the location and status information from the vending machine.

### TECHNICAL FIELD

The present disclosure relates generally to a system and a method for improving security of a vending enclosure such as an automatic teller machine (ATM). Specifically, the present disclosure relates to a wireless system and a method for its use in an enclosure of a vending machine for detecting unauthorized tampering with the machine and for tracking the machine to aid in its recovery.

### BACKGROUND

Vending machines are enclosures where a product is dispensed in exchange for cash, credit or debit from an account. An automatic teller machine (ATM) is a specialized vending machine that allows persons to acquire cash by interacting with the machine, e.g., by inserting a bank card associated with a particular bank account or credit account and entering a personal identification number (PIN). The particular bank account is debited for the cash dispensed. A typical ATM is a cabinet with a front portion providing a terminal screen, a key pad, and various slots for conducting interaction and transactions with a user. The cabinet also includes a hinged door providing access to the interior of the cabinet. The cabinet itself is a high security enclosure with substantial structure and locking mechanisms for the access door. Within the interior compartment, there is housed a variety of components including electronic circuitry, and a stack of drawers or cassettes holding a cash inventory and providing a vault portion of the ATM.

Many ATMs are typically incorporated into a wall structure, e.g., the exterior wall of a bank, and the public have access only to a front panel of the ATM. Bank employees could access the back side of the ATM from inside the bank to perform such tasks as restocking the cash inventory and taking deposits from the vault portion of the ATM. However, increasing numbers of ATMs are now found in a variety of locations, such as at grocery stores, gas stations, shopping malls, small convenience stores, and similar locales. Furthermore, many of these ATMs are often stand-alone structures, i.e., not incorporated into a wall structure. Similarly, there are a number of stand-alone vending machines which could store substantial amounts of cash, such as lottery kiosks or have very high-value products such as MP3 and DVD-player.

The presence of substantial amounts of unattended cash or other valuables in such machines, particularly in standalone scenario, provides a great temptation for thieves to rip apart the machines either on location, or after they have removed the machine to a secure location, in order to access the cash or the valuables stored within.

Modern vending machines such as ATM typically contain sensors that detect when security has been breached and issue warnings to a central location. However, false alarms occur frequently due to improper use by bank or service personnel. Furthermore, even if an alarm is caused by an actual robbery event, the alarm can often be ineffective because by the time someone gets to the site of the machine the thieves may have either torn the machine apart, or removed it from its site to obtain access to the cash or other valuables within. Accordingly, unattended, and especially stand-alone, vending machines are particularly vulnerable to theft. Therefore, there is a need for an improved security system to protect vending machines and to discourage thieves from attacking vending machines, particularly unattended stand-alone units. Because there are at present very a large number of ATMs already in place, there is a need for a system that is inexpensive, reliable, that can be easily retrofitted into existing machine, and requires minimal modification of the machine for installation.

U.S. Pat. Nos. 5,091,713 and 7,183,915 disclose systems to equip ATM and vending machines with various sensors to detect intrusion or theft such as sensors for detecting smoke, heat, seismic motion (impact), tilt, vibration, door opened, or lock opened. The U.S. Pat. No. 5,091,713 patent discloses an alarm that is reported over a wired data link back to a monitoring center. However, there is no disclosure for continued operation of the sensors once the enclosure is removed from an external power source. The U.S. Pat. No. 7,183,915 patent discloses an alarm that causes a dye to be injected into the product (cash) rendering it useless so that further alarms would be unnecessary.

US patent applications 20080075235A1 and 20070081540A1 disclose systems that either manually or automatically provide the installed location of an ATM machine during a robbery to law enforcement. However, neither of these patent applications provides for an update of the location if the enclosure is moved after the alarm. Furthermore, all of the cited patents and patent applications disclose wired communication channels for reporting alarm conditions to a central monitoring facility. These channels may be easily broken if the enclosure is moved or otherwise disconnected from its wired communication capability.

### SUMMARY

Tracking system and method are disclosed herein to provide updated location and status information of a vending machine even after the vending machine is moved from its installed location. This allows law enforcement to use the updated location information to locate and recover the vending machine and the assets contained therein during a theft or in other security breach situations.

In accordance with one or more embodiments of the present invention, a wireless tracking system includes sensors placed within a secured enclosure of a vending machine to detect alarm conditions, and a tracking device placed within the secured enclosure to report wirelessly location and status information of the vending machine to a tracking server when activated by the alarm conditions. The tracking device includes a GNSS (Global Navigation Satellite System) receiver such as a GPS (Global Positioning System) receiver to determine the location, a wireless modem to communicate with the tracking server, and a CPU (Central Processing Unit).

In accordance with one or more embodiments of the present invention, a method of tracking a vending machine includes triggering a sensor placed within a secured enclosure of the vending machine, activating a tracking device also placed within the secured enclosure to determine the location and to generate status information of the vending machine, and reporting wirelessly the location and status information to a tracking server. The tracking server determines from the received status information if security of the vending machine is breached and alerts law enforcement of the location of the vending machine to aid in its recovery.

### BRIEF DESCRIPTION OF THE DRAWINGS

FIG. 1 shows an exterior of an ATM machine containing a tracking system according to one or more embodiments of the present invention.

FIG. 2 shows an interior of the ATM machine of FIG. 1 exposing a tracking system according to one or more embodiments of the present invention.

FIG. 2A shows a detailed view of the tracking system of FIG. 2 according to one or more embodiments of the present invention.

FIG. 3A shows an exterior frontal view of a tracking device according to one or more embodiments of the present invention.

FIG. 3B shows an exterior back view of a tracking device according to one or more embodiments of the present invention.

FIG. 4 shows an inside view of a tracking device, with part of the case removed to expose the internal electronic circuits and components according to one or more embodiments of the present invention.

FIG. 5 shows connection of sensors to a tracking device according to one or more embodiments of the present invention.

FIG. 6 shows a functional block diagram of a tracking device and its power source according to one or more embodiments of the present invention.

FIG. 7 is an illustration of the use of a tracking device in an asset tracking system according to one or more embodiments of the present invention.

FIG. 8 is a flowchart showing the steps in an installation of a tracking device to a vending machine according to one or more embodiments of the present invention.

### DETAILED DESCRIPTION

Embodiments of the present invention are described more fully hereinafter with reference to the accompanying drawings, in which one or more embodiments of the present invention are shown.

Systems and methods are disclosed herein to monitor, track, and recover assets using tracking devices kept within secure enclosures to wirelessly report location and status information of the assets. The secure enclosure may be in a vending machine such as an ATM containing cash or in other vending machines containing valuable assets. The tracking device is activated to report its location when sensors detect unauthorized tampering of the machines such as when the secure enclosure is moved from a fixed location. A tracking server or a monitoring station may receive reports from the tracking device wirelessly and dispatch personnel to aid in the recovery of the assets.

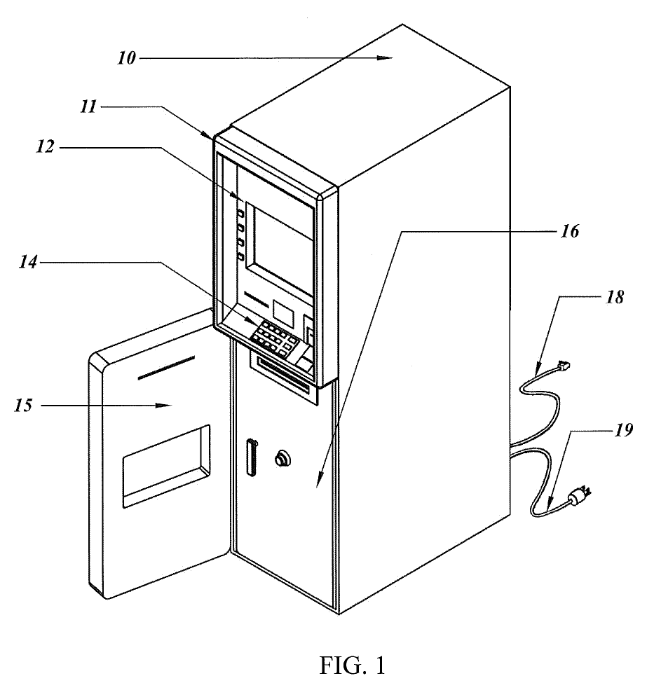

FIG. 1 shows an exterior of an ATM machine containing a tracking system according to one or more embodiments of the present invention. The ATM 10 includes a front panel insert 11, an interface screen or display 12, a keypad or other input interface 14, a front access panel 15, a secure enclosure door 16, a wired data connection 18 and an electrical power input 19. The interface screen 12 and the keypad 14 provide the user input/output interface. The front access panel 15 hides access to the secure enclosure door 16, behind which is secured assets such as cash and the tracking device. Other types of vending machines containing a tracking device may be an electronic device kiosk designed to dispense merchandise in exchange for payment.

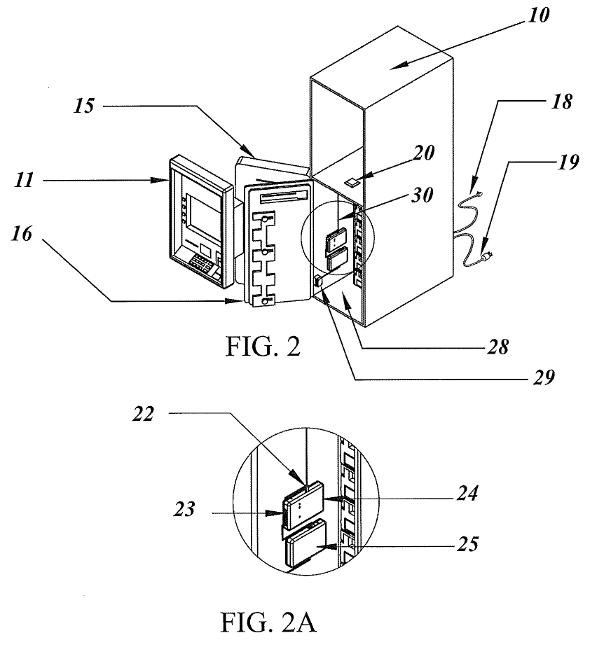

FIG. 2 shows an interior of the ATM machine of FIG. 1 exposing a tracking system according to one or more embodiments of the present invention. In the ATM 10 of FIG. 2 the front panel insert 11 has been removed, the front access panel 15 and the secure enclosure door 16 have also been opened to show the interior of the secure enclosure 28. The secure enclosure 28 may contain assets such as cash and a tracking system.

FIG. 2A shows a detailed view of the tracking system of FIG. 2 according to one or more embodiments of the present invention. The tracking system includes a tracking device 24, a sensor input/conditioning block 25, one or more cables 23 and an antenna connector 22 to connect to an external antenna. The tracking device 24 tracks and reports the location of the assets along with reporting other status information of the assets to a tracking server. The tracking device 24 is connected by one or more cables 23 to the sensor input/conditioning block 25, which receives outputs from sensors detecting a security breach of the secure enclosure 28 or generally monitors conditions reported by sensors on the ATM. These sensors may include a door open/close sensor 29 shown in FIG. 2, or other types of sensors. Alternatively, in one or more other embodiments of the present invention, the sensors may be connected to the tracking device 24 directly without going through the sensor input/conditioning block 25.

Referring again to FIG. 2A, the tracking device 24 has an antenna connector 22 for connecting with an antenna cable 30 and an external tracking antenna 20 of FIG. 2. Tracking device 24 receives signals from a positioning system to calculate its location. The positioning system may be terrestrial-based or satellite-based. An example of a satellite-based positioning system, also referred to as a Global Navigation Satellite System (GNSS) is the Global Positioning System (GPS). GPS comprises a constellation of earth orbiting satellites, also referred to as GPS satellites that constantly transmit orbit information and ranging signals to tracking receivers. A GPS receiver tracks the GPS satellite signals and makes range measurements to the satellites based on the time difference between satellite signal transmission and reception. Using range measurements to at least four GPS satellites, the GPS receiver can determine its three-dimensional position (latitude, longitude, and altitude) and time. The GPS satellite signals travel by line of sight, meaning they will pass through clouds or glass but will not get through most solid objects such as buildings. Therefore, GPS satellite signals are obstructed or their signal strength is degraded by an enclosure of a vending machine. To determine a location of the tracking device 24 during a theft, the signal levels need to be adequate at the tracking device 24. However, when the GPS satellite signal strength becomes too degraded by the secure enclosure 28, position determinations by the tracking device 24 contained within the tracking enclosure 28 may be difficult or impossible. The external tracking antenna 20 allows a second antenna to be located outside of the secure enclosure 28 to improve signal reception characteristics if the signal levels received by a primary antenna inside the secure enclosure 28 are too weak.

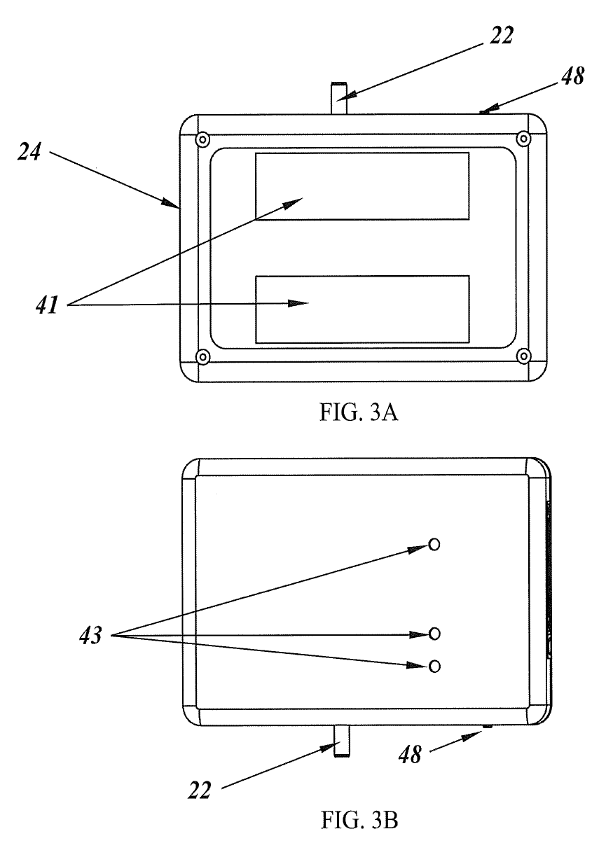

FIG. 3A shows an exterior frontal view and FIG. 3B shows an exterior back view of the tracking device 24 according to one or more embodiments of the present invention. FIG. 3A shows the antenna connector 22 for connecting to an external antenna, an external installation button 48, and removable mounting strips 41. The external installation button 48 is used during the installation process and will be described later. The mounting strips 41 may be made of a hook-and-loop fastener material such as Velcro or some other type of mounting apparatus which allows for quick attachment and removal, but still provides a strong attachment point for the tracking device 24 to the inside of the secure enclosure 28. FIG. 3B shows multiple status Light Emitting Diodes (LEDs) 43 that may provide status information of the tracking device 24 such as internal battery status, GPS/GNSS tracking information (number of satellites tracked), cellular network signal strength and installation status information.

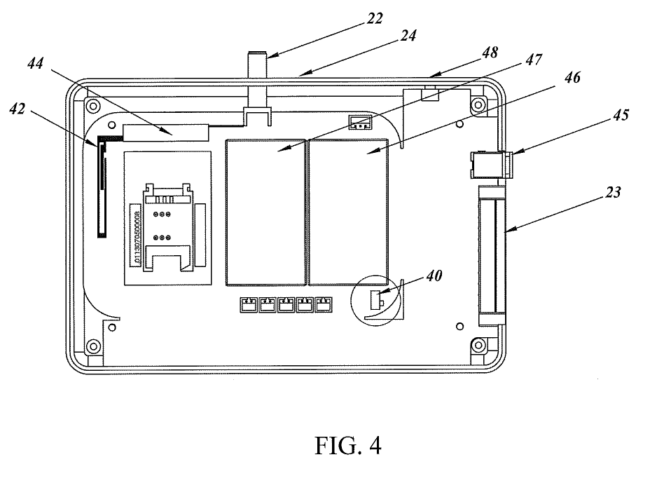

FIG. 4 shows an inside view of the tracking device 24, with part of the case removed to expose the internal electronic circuits and components according to one or more embodiments of the present invention. The tracking device 24 includes a power control switch 40, an antenna connector 22, an internal tracking antenna 42, an antenna power control logic 44, an electronics section 47, an internal battery 46, an external power connector 45, a sensor input connector 23 and an external installation button 48. The power control switch 40 controls the power to the tracking device 24. The antenna connector 22 connects with an external tracking antenna 20 of FIG. 2 for improved reception of tracking signal as described before. The antenna power control logic 44 selects between the external tracking antenna 20 and the internal tracking antenna 42. In one or more embodiments, the antenna power control logic 44 selects the external tracking antenna 20 by default. However, the antenna power control logic 44 senses the current flowing to the external connector 22, and if it falls below a certain threshold, indicating the external tracking antenna 20 is disconnected, or if the current is too high, indicating a short in the connection to the external tracking antenna 20 (the antenna connector 22 or the antenna cable 30 is impinged or broken) power is redirected to the internal tracking antenna 42. The electronic section 47 contains a tracking receiver such as a GPS receiver to track its position, receives inputs from sensors through the sensor input connector 23, and reports location and status information of the secure enclosure 28 wirelessly to a tracking server. The internal battery 46 provides backup power if main power to the ATM through the external power connector 45 is cut off such as when the electrical power input 19 is disconnected during a theft.

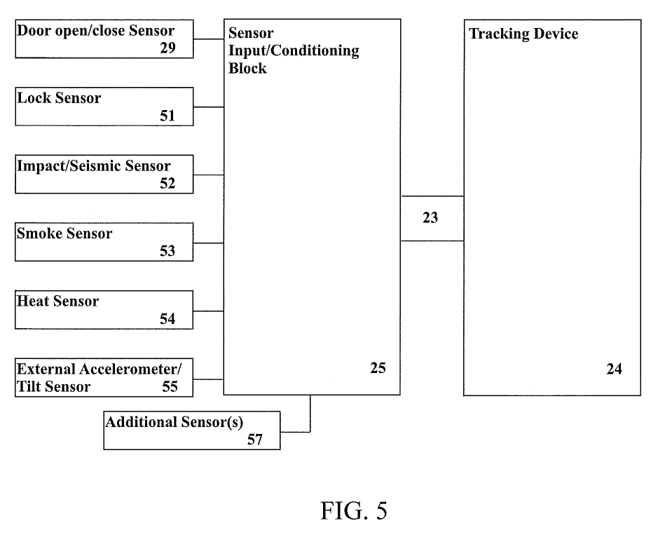

FIG. 5 shows connection of the sensors to the tracking device according to one or more embodiments of the present invention. As described, the sensors detect for conditions indicating a security breach of the secure enclosure 28 or generally monitor conditions of ATM. These sensors may include a door open/close sensor 29, a lock/unlock sensor 5 1, an impact/seismic sensor 52 to detect a sharp jolt during unauthorized tampering of the secure enclosure, a smoke sensor 53, a heat sensor 54, an external accelerometer/tilt sensor 55, or additional sensors 57, which may include but are not limited to a motion sensor. Outputs from the sensors may first go to the sensor input/conditioning block 25 which aggregates and preprocesses the sensor outputs for use by the tracking device 24 through the cables 23. Alternatively, the sensors may be connected to the tracking device 24 directly without going through the sensor input/conditioning block 25. In one or more embodiments, sensors such as the external accelerometer/tilt sensor 55 or the impact/seismic sensor 52 may be located inside the tracking device 24 so that no external connection is required to these sensors.

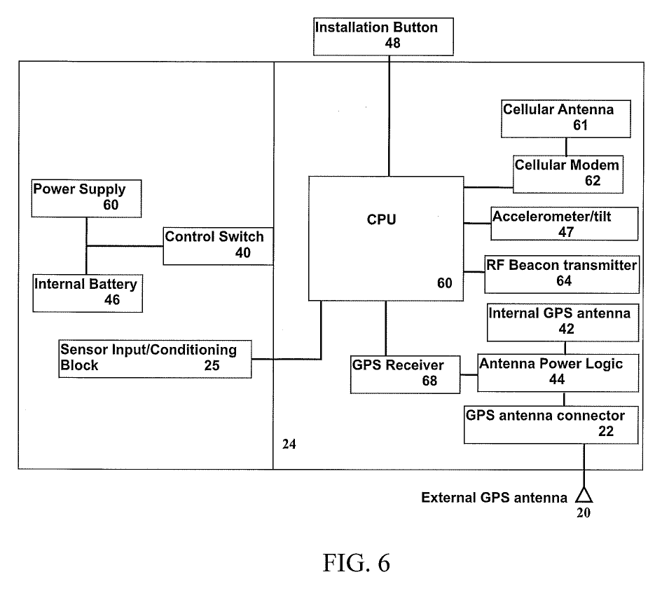

FIG. 6 shows a functional block diagram of the tracking device and its power source according to one or more embodiments of the present invention. Power to the tracking device 24 is supplied from either the main power supply 60 or the internal battery 46 through the power control switch 40. The main power supply 60 may be the power grid supplying power through the external power connector 45 of FIG. 4. The power control switch 40 selects the main power supply 60 by default. However, when the power from the main power supply 60 is cut off, such as during a theft, the power control switch 40 selects the backup power of the internal battery 46 to power the tracking device 24.

The tracking device 24 may include a CPU (central processing unit) 60, a GPS receiver 68, a cellular modem 62, a cellular antenna 61, a RF beacon transmitter 64, sensors such as an internal accelerometer/tilt sensor 47, and an external installation button 48. The CPU 60 monitors and processes sensor data, activates the GPS receiver 68 to track a position, receives commands from a tracking server and reports status information back to the tracking server through the cellular modem 62, receives user input from the external installation button 48, and communicates with the RF beacon transmitter 64. The GPS receiver tracks GPS satellite signals to determine its position. The satellite signals are received by an internal GPS antenna 42 or an external GPS antenna 20. The antenna power control logic 44 selects between the satellite signals received by the external GPS antenna 20 through the GPS antenna connector 22 or the signals received by the internal GPS antenna 42. As described before, the external GPS antenna 20 is located outside of the secure enclosure 28 to improve signal reception characteristics, and may be selected by the antenna power control logic 44 when the signal levels received by the internal GPS antenna 42 inside the secure enclosure 28 are too weak for reliable tracking. The cellular modem 62 sends positions reported by the GPS receiver 68 and status information received from the sensors to the tracking server using the cellular antenna 61. The tracking server may relay the received information to a monitoring station. Personnel at the monitoring station monitor the information and may dispatch security personnel to aid in the recovery of the assets containing the tracking device if there is a theft. The tracking device 24 also uses the cellular modem 62 to receive control commands from the tracking server. Contrary to the GPS antenna, the cellular antenna 61 does not need a second external antenna because the nominal signal levels for cellular signals are between 50 and 80 decibels higher than those for the GPS signal. Therefore, the cellular signal level is adequate for the cellular antenna 61 inside the secure enclosure. Sensor data to the CPU 60 may be provided by the sensor input/conditioning block 25 which aggregates and preprocesses the sensor data, or may be received directly from the sensors such as the internal accelerometer/tilt sensor 47. The RF Beacon transmitter creates a homing beacon signal that allows a handheld device to determine the approximate range and bearing of the tracking device 24 to the handheld device using the beacon signal. The RF Beacon transmitter may optionally have a remote exterior antenna for better performance.

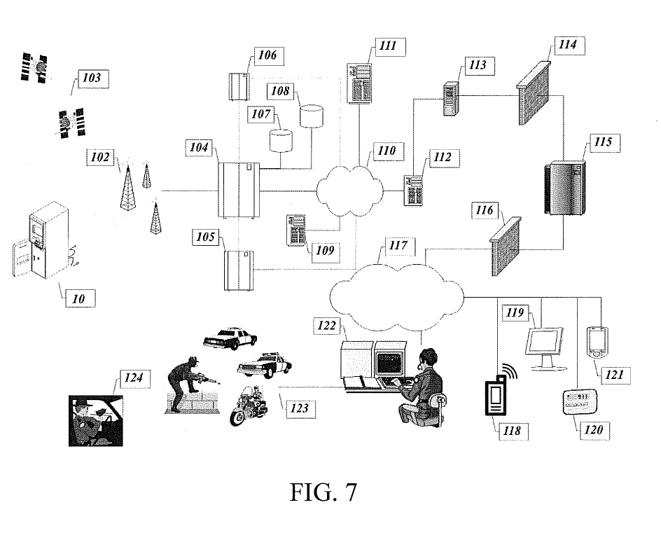

FIG. 7 is an illustration of the use of a tracking device in an asset tracking system according to one or more embodiments of the present invention. The asset tracking system includes an ATM machine 10 containing a tracking device in its enclosure, GPS satellites 103, a cellular data network 102, a tracking server 115, a monitoring station 122, and recovery personnel 123. The tracking device in the ATM machine 10 receives signals from the GPS satellites 103 to determine its location. The tracking device may periodically transmit its location and other status information to the tracking server 115 and the monitoring station 122 through the cellular data network 102. The tracking device may also be activated to report its location and status information either when sensors detect unauthorized tampering of the machines such as when the secure enclosure has been moved, or during installation and servicing of the tracking device by authorized personnel. The cellular data network 102 may route the reported information through a switch 104, a communication backbone 110, a gateway 112, and a protective firewall 114 to the tracking server 115.

During installation of the tracking device to the ATM machine, the tracking server 115 receives the reported information and determines if the reported location is within a boundary of an installation location. If it is, the tracking server 115 assigns or “installs” the tracking device to the installation location. The installation location may also be part of a group of installation locations with shared properties. The tracking device assigned to an installation location inherits the properties associated with the installation location or the properties associated with the group of installation location of which the assigned installation location is a member. These properties may include regional law-enforcement jurisdiction or owner bank security procedure. During installation, the tracking server 115 will not trigger an alert but may allow technical support personnel to monitor the installation at the monitoring station 122. The personnel at the monitoring station 122 may also communicate with the tracking device to arm it and to conduct an initial testing. Further details of the installation process will be described.

After the tracking device is installed and armed, the tracking device may report its location and status information to the tracking server 115 periodically, such as every week in one or more embodiments. The tracking server 115 stores the periodic updates but does not generate an alert. However, when the sensors through the sensor input/conditioning block 25 of FIG. 6 or the sensors within the tracking device indicate alarm conditions, the tracking device is activated immediately to report its location and status information to the tracking server 115. Such alarm conditions may occur when the door open/close sensor 29 of FIG. 5 detects that the door to the enclosure has been opened, when the impact/seismic sensor 52 of FIG. 5 detects a sharp jolt during unauthorized tampering of the ATM, or when the tilt measurement from the internal accelerometer/tilt sensor 47 of FIG. 6 exceeds a threshold relative to a vertical reference value recorded during installation to detect that the ATM is being moved. The tracking server 115 verifies the alarm conditions from the received information, sends out notifications and alarms to the monitoring station 122, and alerts personnel through cell phones 118, computers 119, pagers 120 or personal digital assistants 121. The tracking server 115 also alerts law enforcement 123 having jurisdiction over the installation location to which the ATM is installed. The tracking device will update the reporting of its location and status information at a fast rate, such as once every 6 seconds in one or more embodiments, so that law enforcement 123 dispatched to recover the ATM may have the most up to date location information. The location reporting will continue until either the internal battery is drained or the tracking server 115 issues a disarm command to the tracking device to put it into the disarmed mode.

In the disarmed mode, the tracking device may continue to report its location and status information to the tracking server 115 periodically as in the armed mode. Similarly, when the sensors indicate alarm conditions, the tracking device is activated immediately to report its location and status information to the tracking server 115. However, contrary to the armed mode, the tracking device will not update its location once activated. The tracking device may continue to report status information to allow the tracking server 115 to distinguish between alarm conditions in the disarmed mode from alarm conditions in the armed mode so that law enforcement is not alerted in the disarmed mode. Tracking server 115 may also command the tracking device to go into the disarmed mode when the tracking device is serviced by field personnel or to conserve power when the tracking device is running from the internal battery. To exit from the disarmed mode, the tracking server 115 may command the tracking device to go back to the armed mode.

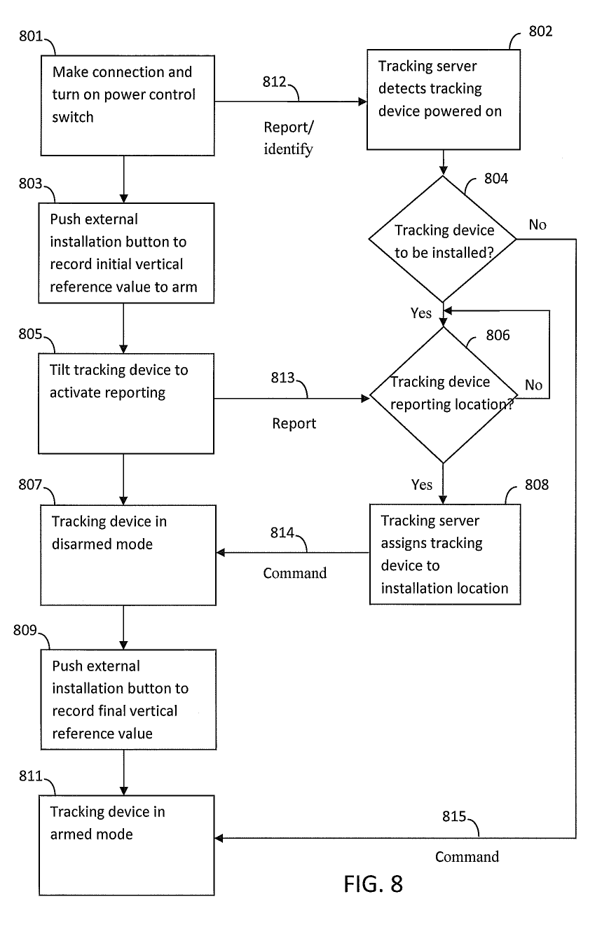

FIG. 8 is a flowchart showing the steps in an installation of a tracking device to a vending machine according to one or more embodiments of the present invention. During installation a tracking server assigns the tracking device to an installation location and the tracking device goes into the armed mode ready to detect and report alarm conditions to the tracking server. Installation involves a field service representative (FSR) taking the tracking device to a location where it is to be installed and activating communication between the tracking device and the tracking server.

Referring to FIG. 8, the left side shows the steps taken by the tracking device and the right side shows the steps taken by the tracking server during installation. Communication between the tracking device and the tracking server is through the cellular data network 102 and the data switching network of FIG. 7. The FSR begins the installation by making connection and turning on the power control switch on the tracking device 801. For example, the FSR may mount the external GPS antenna, route the antenna cable 30, connect the tracking device to the sensor input/conditioning block 25 of FIG. 2, and connect the tracking device to the external GPS antenna and to the main power supply of FIG. 6. The FSR may then remove a cover on the tracking device and switch on the power control switch 40 of FIG. 4 to turn on power to the tracking device. There is no access to the power control switch 40 from outside the secure enclosure 28 to prevent someone who has accessed the interior of the vending machine from turning off the power to the tracking device. As discussed, even when the power from the main power supply 60 is cut off during a theft, the power control switch 40 automatically switches to the backup power of the internal battery 46 of FIG. 4 to power the tracking device.

After the tracking device is powered on, it may report and identify itself to the tracking server (812). To activate the tracking device to report its location, the FSR may put the tracking device into the armed mode and to generate an alarm condition using the internal accelerometer/tilt sensor 47 of FIG. 6. For example, in 803 the FSR may push the external installation button 48 of FIG. 4 to instruct the tracking device to go into the armed mode and to record its current orientation as measured by the internal accelerometer/tilt sensor 47 as an initial vertical reference value. The recorded vertical reference value is to be compared against later measurements from the internal accelerometer/tilt sensor 47 to detect if someone is tampering with the tracking device. An alarm condition may be generated when the difference in tilt angle between the current measurement and the recorded vertical reference value exceeds a certain angular amount for a set period of time. In one or more embodiments, the alarm condition is generated when the difference in tilt angle exceeds 35 degrees for at least 3 seconds. Alternate embodiments of this invention may use a different angular value in conjunction with, or independent from a different set period. In 805 the FSR may then tilt the tracking device by more than 35 degrees for more than 3 seconds to force an alarm condition and to activate the tracking device to report its location and status information to the tracking server in 813. Activation of the tracking device to report during the installation may also be accomplished in other ways. In one or more embodiments, the FSR may force an alarm condition from the disarmed mode such that the tracking device only reports its location once and not update the location at a fast rate as in the armed mode. In other embodiments, upon power up the tracking device may automatically report its location once without requiring input from the FSR to force an alarm condition.

After detecting the presence of the tracking device following power on in 802, the tracking server may determine if the tracking device is to be installed to an installation location in 804. If the tracking device has already been installed, the tracking server may simply generate a command in 815 to put the tracking device into the armed mode. For example, if there is a power outage to a tracking device that has already been installed and the internal battery has depleted its charge, after power is restored, the tracking server may bypass the installation steps to put the tracking device into the armed mode directly. On the other hand, if the tracking device is to be installed, the tracking server may wait for the tracking device to reports its location and status information in 806. As discussed before, the tracking server receives the reported information of 813 and determines if the reported location is within a boundary of an installation location. If it is, the tracking server assigns or installs the tracking device to the installation location in 808. The tracking device may thus inherit properties associated with the assigned installation location. The tracking server may then send a command in 814 to the tracking device to indicate that the tracking device has been installed and to put the tracking device into the disarmed mode.

Upon receiving the command of 814 from the tracking server, the tracking device may turn on an external LED of FIG. 4 to indicate to the FSR that the installation is complete. The tracking device may then go into the disarmed mode in 807. The FSR may then attach the tracking device to the interior wall of the secure enclosure 28 with the mounting strips of FIG. 3. In 809, the FSR may push the external installation button a second time to instruct the tracking device to go into the armed mode again and to record the orientation measurement from the internal accelerometer/tilt sensor 47 for a final vertical reference value. The tracking device will then enter the armed mode in 811 to wait for an alarm condition and to periodically report its location and status information to the tracking server.

The foregoing embodiments are illustrative of the present invention and are not to be construed as limiting thereof. Although one or more embodiments of the present invention have been described, those skilled in the art will readily appreciate that many modifications in form and detail to the embodiments are possible without materially departing from the spirit and scope of the present invention. Accordingly, all such modifications are intended to be included within the scope of the present invention as defined in the claims.

What is claimed is:

1. A wireless security system comprising:
one or more sensors placed within a secured enclosure to detect one or more alarm conditions; and
a tracking device placed within the secured enclosure and adapted to receive the one or more alarm conditions, wherein the one or more alarm conditions activate the tracking device to report wirelessly a location and status information of the tracking device.

2. The wireless security system of claim 1, wherein the tracking device comprises:
a GNSS (Global Navigation Satellite System) receiver to determine the location of the tracking device;
a wireless m odem adapted to transmit wirelessly the location and the status information of the tracking device, and to receive a command wirelessly; and
a CPU (central processing unit) adapted to process the one or more alarm conditions from the one or more sensors, to process the location of the tracking device from the GNSS receiver, to process the command from the wireless modem, and to generate the status information to the wireless modem.

3. The wireless security system of claim 2, wherein the tracking device further comprises:
an internal tracking antenna placed inside the secured enclosure;
an external tracking antenna placed outside the secured enclosure; and
an antenna power logic adapted to receive the internal tracking antenna and the external tracking antenna, wherein the GNSS receiver receives satellite signals from the external tracking antenna if the antenna power logic senses that a current from the external tracking antenna is within a range and the GNSS receiver receives satellite signals from the internal tracking antenna otherwise.

4. The wireless security system of claim 2, wherein the tracking device further comprises an internal battery adapted to provide backup power to the tracking device.

5. The wireless security system of claim 2, wherein the tracking device further comprises:
a tilt sensor to measure a tilt angle of the tracking device continuously; and
an external installation button adapted to record a first tilt angle of the tracking device as a vertical reference value when the external installation button is pushed.

6. The wireless security system of claim 5, wherein if a difference between a second tilt angle and the vertical reference value is greater than a threshold angle lasting for more than a minimum time period, the tracking device is activated to report wirelessly the location and status information of the tracking device.

7. The wireless security system of claim 1, further comprising a sensor input/conditioning block, wherein the sensor/input conditioning block aggregates and preprocesses the alarm conditions for use by the tracking device.

8. The wireless security system of claim 2, wherein the tracking device further comprises a RF (radio frequency) beacon transmitter adapted to transmit a RF homing beacon of the tracking device.

9. The wireless security system of claim 1, wherein the tracking device is further adapted to report the location and status information periodically when the tracking device is not activated by the one or more alarm conditions.

10. The wireless security system of claim 1, further comprising a tracking server adapted to receive the location and status information from the tracking device, to transmit command information to the tracking device, and to generate alert information to aid in recovery of the secured enclosure.

11. The wireless security system of claim 10, wherein during an installation of the tracking device the tracking server assigns the tracking device to an installation location based on the location received from the tracking device for the tracking device to inherit one or more properties associated with the installation location.

12. A wireless security system comprising:
one or more sensors placed within a vault of an automatic teller machine (ATM) to detect one or more alarm conditions; and
a tracking device placed within the vault and adapted to receive the one or more alarm conditions, wherein the one or more alarm conditions activate the tracking device to report wirelessly a location and status information of the ATM.

13. The wireless security system of claim 12, wherein the tracking device comprises:
a GPS (Global Positioning System) receiver to determine the location of the ATM;
a wireless modem adapted to transmit wirelessly the location and the status information of the ATM, and to receive a command wirelessly; and
a CPU (central processing unit) adapted to process the one or more alarm conditions from the one or more sensors, to process the location of the ATM from the GPS receiver, to process the command from the wireless modem, and to generate the status information to the wireless modem.

14. The wireless security system of claim 13, wherein the tracking device further comprises:
an internal GPS antenna placed inside the vault;
an external GPS antenna placed outside the vault; and
an antenna power logic adapted to receive the internal GPS antenna and the external GPS antenna, wherein the GPS receiver receives satellite signals from the external GPS antenna if the antenna power logic senses that a current from the external GPS antenna is within a range and the GPS receiver receives satellite signals from the internal GPS antenna otherwise.

15. The wireless security system of claim 13, wherein the tracking device further comprises an internal battery adapted to provide backup power to the tracking device.

16. The wireless security system of claim 12, further comprising a sensor input/conditioning block, wherein the sensor/input conditioning block aggregates and preprocesses the alarm conditions for use by the tracking device.

17. A method of tracking a secured enclosure, the method comprising:
triggering a sensor placed within the secured enclosure;
activating a tracking device placed within the secured enclosure to determine a location and to generate status information of the secured enclosure; and
reporting wirelessly the location and status information to a tracking server.

18. The method of claim 17, further comprising:
determining from the status information at the tracking server that security of the secured enclosure is breached; and
alerting law enforcement of the location of the secured enclosure.

19. A method of installing a tracking device to a secured enclosure, the method comprising:
triggering a sensor placed within the secured enclosure;
activating a tracking device placed within the secured enclosure to determine a location and to generate status information of the secured enclosure;
reporting wirelessly the location and status information to a tracking server; and
assigning the tracking device by the tracking server to an installation location based on the location received.

20. The method of claim 19, wherein said triggering a sensor comprises:
recording a first tilt angle from a tilt sensor of the secured enclosure as a vertical reference value;
measuring continuously a second tilt angle from the tilt sensor;
comparing the vertical reference value with the second tilt angle to generate a tilt difference continuously; and
activating the tracking device when the tilt difference is greater than a threshold angle for more than a minimum time period.
